(19) United States
(12) Patent Application Publication
(10) Pub. No.: US 2024/0098798 A1
(43) Pub. Date: Mar. 21, 2024

(54) MECHANISM FOR CELL ACTIVATION

(71) Applicant: Nokia Technologies Oy, Espoo (FI)

(72) Inventors: Lars DALSGAARD, Oulu (FI); Lei DU, Beijing (CN); Yueji CHEN, Hangzhou (CN)

(21) Appl. No.: 18/264,022

(22) PCT Filed: Feb. 22, 2021
(86) PCT No.: PCT/CN2021/077291

§ 371 Date: Aug. 2, 2023

(51) Int. Cl. H04W 74/0833; H04B 7/06; H04L 5/00; H04W 74/00

(52) U.S. Cl. CPC H04W 74/0833; H04B 7/0626; H04L 5/0051; H04W 74/004

(57) ABSTRACT

According to embodiments of the present disclosure, after a terminal device receives an activation indication from a network device to activate a secondary cell configured with physical uplink control channel or a primary secondary cell, the terminal device transmits an acknowledgment in response to the activation indication to the network device. The terminal device measures one or more reference signals related to the SCell while activating the SCell and performing a random access procedure to the network device. In this way, it can shorten delay for SCell activation and reduce latency.

### FIELD

Embodiments of the present disclosure generally relate to the field of telecommunication and in particular, to methods, devices, apparatuses and computer readable storage medium for cell activation.

### BACKGROUND

With development of communication technologies, it requires larger communication capacity. In some scenarios, a terminal device can be configured with a plurality of cells. For example, carrier aggregation (CA) is proposed. CA is a technique used in wireless communication to increase a data rate per user or extend the coverage, where multiple component carriers are configured to a same user. In Carrier Aggregation (CA), two or more Component Carriers (CCs) are aggregated. A UE may simultaneously receive or transmit on one or multiple CCs depending on its capabilities. A component carrier is referred to as a serving cell and it is treated as such by higher layers. In frequency division duplex (FDD), a serving cell comprises a pair of different downlink and uplink carrier frequencies, while in time division duplex (TDD) a single carrier frequency is used with downlink and uplink transmissions in different time intervals.

### SUMMARY

In general, example embodiments of the present disclosure provide a solution for cell activation.

In a first aspect, there is provided a first device. The first device comprises at least one processor; and at least one memory including computer program codes; the at least one memory and the computer program codes are configured to, with the at least one processor, cause the first device to receive, via a first cell of a second device an activation indication to activate a second cell of a third device; monitor a first set of reference signals from the second cell; determine, based on the first set of reference signal a downlink timing in the second cell; and measure a second set of reference signals in the second cell of the third device while performing activation of the second cell and a random access procedure to the second cell.

In a second aspect, there is provided a third device. The third device comprises at least one processor; and at least one memory including computer program codes; the at least one memory and the computer program codes are configured to, with the at least one processor, cause the third device to transmit, to a first device, a first set of reference signals in a second cell of the third device; and transmit, to the first device, a second set of reference signals while performing activation of the second cell and a random access procedure with the first device.

In a third aspect, there is provided a method. The method comprises receiving, at a first device and via a first cell of a second device, an activation indication to activate a second cell of a third device; monitoring a first set of reference signals from the second cell; determining, based on the first set of reference signal a downlink timing in the second cell; and measuring a second set of reference signals from the second cell of the third device while performing activation of the second cell and a random access procedure to the second cell.

In a fourth aspect, there is provided a method. The method comprises transmitting, to a first device, a first set of reference signals in a second cell of a third device; and transmitting, to the first device, a second set of reference signals e.g. while performing a random access procedure with the first device.

In a fifth aspect, there is provided an apparatus. The apparatus comprise means for receiving, at a first device and via a first cell of a second device, an activation indication to activate a second cell of a third device; means for monitoring a first set of reference signals from the second cell; means for determining, based on the first set of reference signal a downlink timing in the second cell; and means for measuring a second set of reference signals from the second cell of the third device while performing activation of the second cell and a random access procedure to the second cell.

In a sixth aspect, there is provided an apparatus. The apparatus comprises means for transmitting, to a first device, a first set of reference signals in a second cell of a third device; and means for transmitting, to the first device, a second set of reference signals while performing a random access procedure with the first device.

In a seventh aspect, there is provided a computer readable medium. The computer readable medium comprises program instructions for causing an apparatus to perform at least the method according to any one of the above third and fourth aspects.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates a signaling flow for cell activation according to conventional technologies;

FIG. 2 illustrates a signaling flow for cell activation according to conventional technologies;

FIG. 3 illustrates an example communication environment in which example embodiments of the present disclosure can be implemented;

FIG. 4 illustrates a signaling flow for cell activation according to some example embodiments of the present disclosure;

FIG. 5 illustrates a flowchart of a method implemented at a first apparatus according to some example embodiments of the present disclosure;

FIG. 6 illustrates a flowchart of a method implemented at a second apparatus according to some other example embodiments of the present disclosure;

FIG. 7 illustrates a simplified block diagram of an apparatus that is suitable for implementing example embodiments of the present disclosure; and

FIG. 8 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, an Integrated and Access Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. The term “terminal device” refers to any end device that may be capable of wireless communication. In the following description, the terms “terminal device”, “terminal”, “user equipment” and “UE” may be used interchangeably.

As mentioned above, a terminal device has a single serving cell and it is referred to as a primary cell (PCell) and other serving cells are called secondary cell (SCell). With a radio resource control (RRC) connection on the PCell, a network device can further configure one or more SCells for the terminal device. According to some conventional technologies, PCell can be used for uplink transmission. In order to improve capacity, in LTE system, 3GPP has introduced SCell configured with UL including physical uplink control channel (PUCCH). This SCell is named PUCCH SCell. Based on this, there are necessary UE minimum activation delay requirements for activation of such SCell.

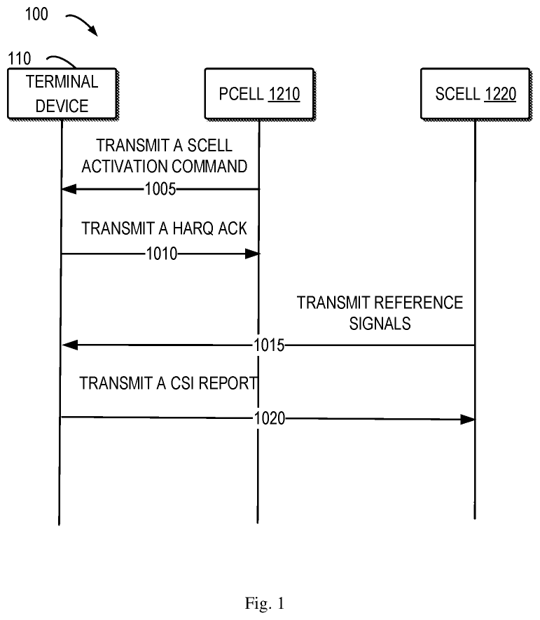

FIG. 1 illustrates a signaling flow for non-PUCCH SCell activation according to conventional technologies. As shown in FIG. 1, a network device 120 can transmit 1005 a SCell activation command to a terminal device 110 in a PCell 1210. The terminal device 110 can transmit 1010 a hybrid automatic repeat request (HARQ) acknowledgement in response to the activation command to the PCell 1210. The network device 120 transmits 1015 one or more reference signals to the terminal device 110 in the SCell 1220. The terminal device 110 can measure the one or more reference signals and generate a channel state information (CSI) report based on measurement results of the one or more reference signals. The terminal device 110 can transmit 1020 the CSI report to the network device 120 in the PCell 1210. In this situation, the activation delay can comprise an activation time duration and a CSI measurement and reporting duration.

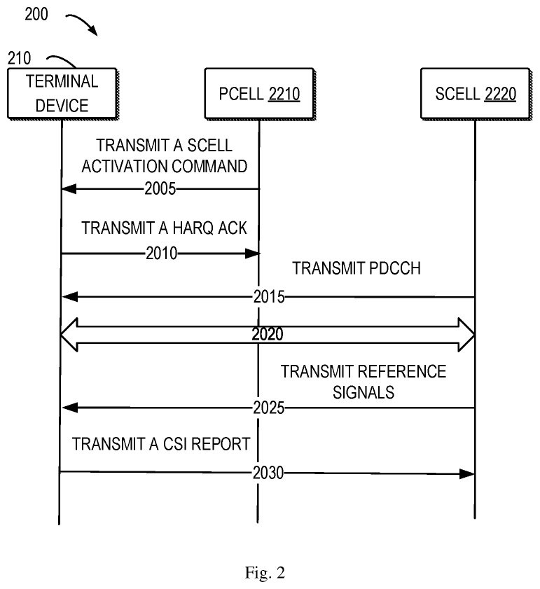

FIG. 2 illustrates a signaling flow for PUCCH SCell activation according to conventional technologies. As shown in FIG. 2, a network device 220 can transmit 2005 a SCell activation command to a terminal device 210 in a PCell 2210. The terminal device 210 can transmit 2010 a HARQ acknowledgement in response to the activation command to the PCell 2210. The network device 220 can transmit 2015 a PDCCH order to trigger the UE initiating a random access procedure. The terminal device 210 can perform 2020 the random access procedure. After the random access procedure is completed, the terminal device 210 can generate a channel state information (CSI) report based on measurement results of the one or more reference signals. The terminal device 210 can transmit 2030 the CSI report to the network device 220 in the SCell 2220. In this situation, the activation delay can comprise a combination of: an activation time duration, a time duration for the random access procedure and reporting duration.

The SCell activation delay requirement for deactivated PUCCH SCell should apply for the terminal device configured with one downlink SCell and when PUCCH is configured for the SCell being activated. If the terminal device has a valid TA for transmitting on an SCell then the terminal device shall be able to transmit valid CSI report and apply actions related to the SCell activation command as shown in FIG. 2 for the SCell being activated on the PUCCH SCell no later than in subframe n+T_{activate_basic}, where: a TA is considered to be valid provided that the TimeAlignmentTimer associated with the TAG containing the PUCCH SCell is running; T_{activate_basic} represents the SCell activation delay for deactivated non-PUCCH SCell.

If the terminal device does not have a valid TA for transmitting on an SCell then the terminal device shall be capable to perform downlink actions related to the SCell activation command for the SCell being activated on the PUCCH SCell no later than in subframe n+T_{activate_basic} Further, the terminal device shall be capable to perform uplink actions related to the SCell activation command for the SCell being activated on the PUCCH SCell no later than in subframe n+T_{delay_PUCCH SCell}. Moreover, the terminal device shall transmit valid CSI report for the SCell being activated on the PUCCH SCell no later than in subframe n+T_{delay_PUCCH SCell}, where: T_{delay_PUCCH SCell}=T_{activate_basic}+T1+T2+T3 and where T1 represents the delay uncertainty in acquiring the first available PRACH occasion in the PUCCH SCell. T1 can be up to 25 subframes and the actual value of T1 shall depend upon the PRACH configuration used in the PUCCH SCell. T2 represents the delay for obtaining a valid TA command for the sTAG to which the SCell configured with PUCCH belongs. T2 can be up to 13 subframes. T3 represents the delay for applying the received TA for uplink transmission. T3 can be 6 subframes.

The above delay requirement (T_{delay_PUCCH SCell}) shall apply provided that: the terminal device has received a PDCCH order to initiate random access (RA) procedure on the PUCCH SCell within T_{activate_basic} otherwise additional delay to activate the SCell is expected; and the RA on PUCCH SCell is not interrupted by the RA on PCell otherwise additional delay to activate the SCell is expected; and no SRS carrier based switching occurs during the SCell activation procedure otherwise the PUCCH SCell activation delay (T_{delay_PUCCH SCell}) can be extended.

Alternatively, the SCell activation delay requirement for deactivated non-PUCCH SCell shall apply to the terminal device configured with one downlink SCell. The requirements can be applicable for E-UTRA FDD, E-UTRA TDD and E-UTRA TDD-FDD carrier aggregation. The requirements can also be applicable for E-UTRAN-NR Dual Connectivity (EN-DC). Further, the requirements can also be applicable for the UE operating in NR-E-UTRAN DC (NE-DC). The delay within which the terminal device shall be able to activate the deactivated SCell depends upon the specified conditions.

For LTE, T_{activate_basic}, upon receiving SCell activation command in subframe n, the terminal device shall be capable to transmit valid CSI report and apply actions related to the activation command for the SCell being activated no later than in subframe n+N_{act_known} provided the following conditions are met for the SCell:

During the period equal to 5 SCell measurement Cycle(measCycleSCell) or 5 discontinuous reception (DRX) cycles before the reception of the SCell activation command: the terminal device has sent a valid measurement report for the SCell being activated and the SCell being activated remains detectable according to the cell identification conditions.

SCell being activated also remains detectable during the SCell activation delay according to the cell identification conditions, where N_{act_known}=24.

This added delay on terminal device side is allowed to enable UE time for turning on or retuning the radio frequency (when needed) and for performing the necessary CSI measurement. Hereafter, the UE shall be able to transmit the CSI report. For new radio (NR), conventional technologies have so far not developed similar requirements for PUCCH SCell activation delay requirements.

Current LTE legacy requirements are based on an assumption of LTE downlink (DL) reference signals which are available for the terminal device in a continuous manner. This is not the case in the baseline assumed NR deployment, where the assumption is that the needed NR reference signals are available once per 20 ms.

The current NR SCell activation delay requirement defined for NR in Rel-15 (for a non-PUCCH SCell) are based on LTE requirements and therefore rather similar to those defined for LTE with the addition of covering the frequency range 2 (FR2) specifics in addition to frequency range 1 (FR1).

The requirements for activation of a non-PUCCH SCell in NR, for the terminal device configured with one downlink SCell in EN-DC, or in standalone NR carrier aggregation or in NE-DC or in NR-DC and when one SCell is being activated, are discussed next. The delay within which the UE shall be able to activate the deactivated SCell depends upon the specified conditions.

Upon receiving SCell activation command in slot n, the UE shall be capable to transmit valid CSI report and apply actions related to the activation command for the SCell being activated no later than in slot

$$n + \frac{{T}_{H A R Q} + {T}_{activation\_time} + {T}_{CSI\_Reporting}}{NR slot length} ,$$

where T_{HARQ} (in ms) represents a timing between DL data transmission and acknowledgement; T_{activation_time} represents the SCell activation delay in millisecond; and T_{CSI_reporting} represents the delay (in ms) including uncertainty in acquiring the first available downlink CSI reference resource, UE processing time for CSI reporting and uncertainty in acquiring the first available CSI reporting resources.

Considering the PUCCH SCell in NR and the T_{activation_time}, it can be assumed that the PUCCH SCell in many cases may not be collocated, for example, with the PCell. This means that the T_{activation_time} can be expected to be as long as:

If the SCell being activated belongs to FR2 and if there is no active serving cell on that FR2 band provided that PCell or PSCell is in FR1 or in FR2:

If the target SCell is known to UE and semi-persistent CSI-RS is used for CSI reporting, then T_{activation_time} is as below:
3 ms+max(T_{uncertainty_MAC}+T_{FineTiming}+2 ms, T_{uncertainty_SP}), where T_{uncertainty_MAC}=0 and T_{uncertainty_SP}=0 if UE receives the SCell activation command, semi-persistent CSI-RS activation command and TCI state activation command at the same time.

If the target SCell is known to UE and periodic CSI-RS is used for CSI reporting, then T_{activation_time} is:
max(T_{uncertainty_MAC}+5 ms+T_{FineTiming}, T_{uncertainty_RRC}+T_{RRC_delay-THARQ}), where T_{uncertainty_MAC}=0 if UE receives the SCell activation command and TCI state activation commands at the same time.

If the PCell/PSCell and the target SCell are in a band pair with independent beam management and the target SCell is unknown to UE and semi-persistent CSI-RS is used for CSI reporting, provided that the side condition Ês/Iot≥−2 dB is fulfilled, then Tactivation_time is:

6 ms+T_{FirstSSB_MAX}+15*T_{SMTC_MAX}+8*Tᵣₛ+T_{L1-RSRP,measure}+T_{L1-RSRP,report}+T_{HARQ}+MaX(T_{uncertainty_MAC}+T_{FineTiming}+2 ms,T_{uncertainty_SP}).

If the PCell/PSCell and the target SCell are in a band pair with independent beam management and the target SCell is unknown to UE and periodic CSI-RS is used for CSI reporting, provided that the side condition Ês/Iot≥−2 dB is fulfilled, then T_{activation_time} is:

3 ms+T_{FirstSSB_MAX}+15*T_{SMTC_MAX}+8*TᵣₛT_{L1-RSRP,measure}+T_{L1-RSRP,report}+max{(T_{HARQ}+T_{uncertainty_MAC}+5 ms+T_{FineTiming}),(T_{uncertainty_RRC}+T_{RRC_delay})}.

where,
T_{SMTC_MAX}: in FR1, in case of intra-band SCell activation, T_{SMTC_MAX} represents the longer SMTC periodicity between active serving cells and SCell being activated provided the cell specific reference signals from the active serving cells and the SCells being activated or released are available in the same slot; in case of inter-band SCell activation, T_{SMTC_MAX} represents the SMTC periodicity of SCell being activated; in FR2, T_{SMTC_MAX} represents the longer SMTC periodicity between active serving cells and SCell being activated provided that in Rel-15 only support FR2 intra-band CA. T_{SMTC_MAX} can be bounded to a minimum value of 10 ms.
Tᵣₛ represents the SMTC periodicity of the SCell being activated if the UE has been provided with an SMTC configuration for the SCell in SCell addition message, otherwise Tᵣₛ represents the SMTC configured in the measObjectNR having the same synchronization signal block (SSB) frequency and subcarrier spacing; if the UE is not provided SMTC configuration or measurement object on this frequency, the requirement which involves Tᵣₛ is applied with Tᵣₛ=5 ms assuming the SSB transmission periodicity is ms; there are no requirements if the SSB transmission periodicity is not 5 ms
T_{FirstSSB} represents the time to the end of the first complete SSB burst indicated by the SMTC after slot

$$n + \frac{{T}_{H A R Q} + 3 ms}{NR slot length}$$

T_{FirstSSB_MAX} represents the time to the end of the first complete SSB burst indicated by the SMTC after slot

$$n + \frac{{T}_{H A R Q} + 3 ms}{NR slot length} ,$$

further fulfilling:
In FR1, in case of intra-band SCell activation, the occasion when all active serving cells and SCells being activated or released are transmitting SSB bursts in the same slot; in case of inter-band SCell activation, the first occasion when the SCell being activated is transmitting SSB burst.
In FR2, the occasion when all active serving cells and SCells being activated or released are transmitting SSB bursts in the same slot.
T_{FineTiming} represents the time period between UE finishes processing the last activation command for PDCCH TCI, physical downlink shared channel (PDSCH) TCI (when applicable) and the timing of first complete available SSB corresponding to the TCI state.
T_{L1-RSRP, measure} represents L1-Reference Signal Received Power (L1-RSRP) measurement delay T_{L1-RSRP_Measurement_Period_SSB} ms or T_{L1-RSRP_Measurement_Period_CSI-RS} based on applicability as defined in clause 9.5 assuming M=1.
T_{L1-RSRP, report} represents delay of acquiring CSI reporting resources.
T_{uncertanity_MAC} represents the time period between reception of the last activation command for PDCCH TCI, PDSCH TCI (when applicable) relative to SCell activation command for known case; First valid L1-RSRP reporting for unknown case.
T_{uncertanity_RRC} represents the time period between reception of the RRC configuration message for TCI of periodic CSI-RS for CQI reporting (when applicable) relative to SCell activation command for known case; First valid L1-RSRP reporting for unknown case.
T_{uncertanity_SP} represents the time period between reception of the activation command for semi-persistent CSI-RS resource set for CQI reporting relative to SCell activation command for known case; First valid L1-RSRP reporting for unknown case.
T_{RRC_delay} represents the RRC procedure delay.

Longer delays for radio resource management (RRM) measurement requirements, and in case of FR2 also SSB based radio link monitoring (RLM)/bidirectional forwarding detection (BFD)/L1-RSRP) measurement requirements, can be expected during the cell detection time for unknown SCell activation.

As can be recognized, if simply adopting the LTE approach for PUCCH SCell activation delay requirements and simply defining the PUCCH SCell activation delay by increasing the non-PUCCH SCell activation delay with the physical random access channel (PRACH) procedure delay for obtaining TA, it will lead to very relaxed UE requirements and extended NR PUCCH SCell activation delay. Such extended delay is of course not beneficial for the system performance and should be reduced.

Therefore, new solutions on PUCCH SCell or primary secondary cell activation for NR are required. According to embodiments of the present disclosure, after a terminal device receives an activation command indication from a network device to activate a PUCCH SCell or a primary secondary cell, the terminal device transmits an acknowledgment in response to the activation indication to the network device. The terminal device measures one or more reference signals related to the SCell while performing activation of the PUCCH SCell or the primary secondary cell and random access procedure to the network device. In this way, it can shorten delay for SCell activation and reduce latency.

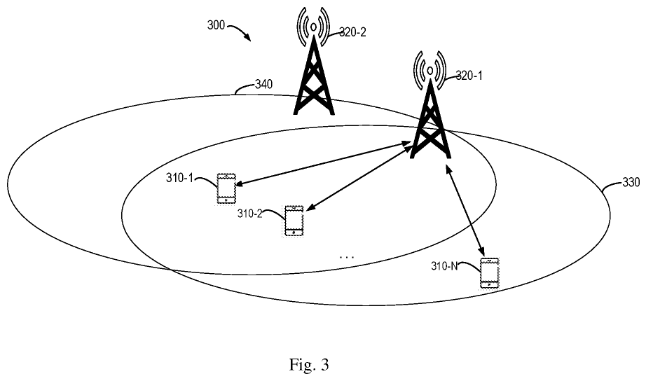

FIG. 3 illustrates a schematic diagram of a communication environment 300 in which embodiments of the present disclosure can be implemented. The communication environment 300, which is a part of a communication network, further comprises a device 310-1, a device 310-2, . . . , a device 310-N, which can be collectively referred to as “first device(s) 310.” The communication environment 300 comprises a device 320-1, a device 320-2, . . . , a device 320-M, which can be collectively referred to as “device(s) 320.” The number N and the number M can be any suitable integer numbers.

The communication environment 300 may comprise any suitable number of devices and cells. In the communication environment 300, the first device 310 and the device 320 can communicate data and control information to each other. In the case that the first device 310 is the terminal device and the device 320 is the network device, a link from the device 320 to the first device 310 is referred to as a downlink (DL), while a link from the first device 310 to the device 320 is referred to as an uplink (UL). The device 320 and the first device 310 are interchangeable. The first device 310 can be configured with more than one cell. Only for the purpose of illustrations, the first device 310 can be configured with a first cell 330 and a second cell 340. In some embodiments, the first cell 330 and the second cell 340 can be collocated. For example, the device 320-1 can comprise the first cell 330 and the second cell 340. Alternatively, the first cell and the second cell may not be collocated. For example, the device 320-1 can comprise the first cell 330 and the device 320-2 can comprise the second cell 340. Only for the purpose of illustrations, the device 320-1 can be referred to as the second device and the device 320-2 can be referred to as the third device. It should be noted that the second device and the third device are interchangeable. In some embodiments, if the cells are collocated, the second device and the third device can be the same device.

Only for the purpose of illustrations, the first cell 330 can be a primary cell (PCell). In some embodiments, the second cell 340 can be a secondary cell with PUCCH. Alternatively, the second cell 340 can be a primary secondary cell (PSCell). The term “primary cell” used herein can refer to a master cell group (MCG) cell which is operating on the primary frequency, in which the UE either performs the initial connection establishment procedure or initiates the connection re-establishment procedure. The term “secondary cell” used herein can refer to a cell, for a UE configured with CA, providing additional radio resources on top of Special Cell. For a UE in RRC_CONNECTED not configured with carrier aggregation (CA)/dual-connectivity (DC), there is only one serving cell comprising of the primary cell. For a UE in RRC_CONNECTED configured with CA/DC, the term “serving cells” is used to denote the set of cells comprising of the Special Cell(s) and all secondary cells. The term “PSCell” user herein can refer to a primary cell of a secondary cell group (SCG).

It is to be understood that the number of first devices and cells and their connections shown in FIG. 3 is given for the purpose of illustration without suggesting any limitations. The communication environment 300 may include any suitable number of devices and networks adapted for implementing embodiments of the present disclosure.

Communications in the communication environment 300 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

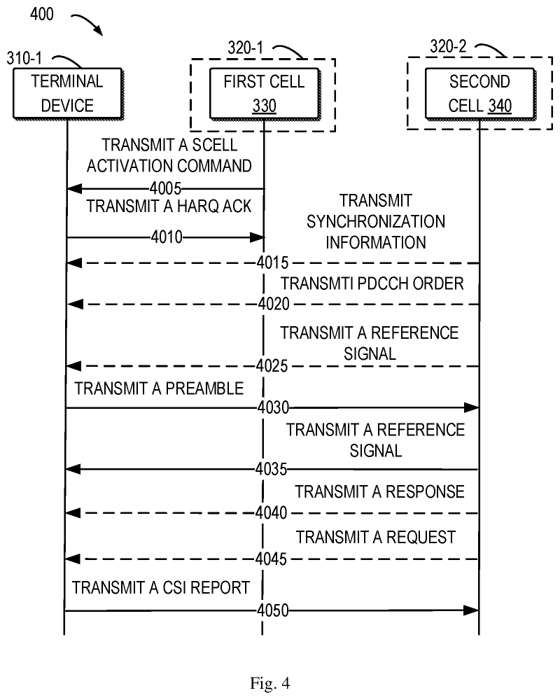

Example embodiments of the present disclosure will be described in detail below with reference to the accompanying drawings. Reference is now made to FIG. 4, which illustrates a signaling flow 400 for PUCCH SCell activation or PSCell activation according to example embodiments of the present disclosure. For the purpose of discussion, the signaling flow 400 will be described with reference to FIG. 3. Only for the purpose of illustrations, the signaling flow 400 may involve the first device 310-1 and the second device 320. As mentioned above, the first cell 330 and the second cell 340 may be collocated. Alternatively, the first cell 330 and the second cell 340 may not be collocated. Only for the purpose of illustrations, the signaling flow 400 is described with a reference to the scenario where the first cell 330 and the second cell 340 are not collocated, the second device 320-1 comprises the first cell 330 and the third device 320-2 comprises the second cell 340.

The device 320-1 transmits 4005 an activation indication in the first cell 330 to the first device 310-1 to activate the second cell 340 of the device 320-2. The first device 310-1 is configured with a PUCCH SCell and can perform PUCCH transmission on the second cell 340. For example, the activation indication can comprise an identity of the second cell 340. In some embodiments, the first device 310-1 can be configured with more than one SCells. The device 320-1 may configure a SCell and/or a PUCCH SCell in a deactivated state. Alternatively, the device 320-1 may configure a SCell and/or a PUCCH SCell in an activated state. The first device 310-1 can be configured with the information that the second cell 340 can be regarded as the SCell with PUCCH. The activation indication can be transmitted in any proper signaling.

In some embodiments, the first device 310-1 can transmit 4010 an acknowledgement in response to the activation indication to the device 320 in the first cell 330. For example, the HARQ acknowledgement can be transmitted.

After the first device 310-1 sends the acknowledgment, the first device 310-1 may start obtaining DL timing of the second cell 340. In some embodiments, the first device 310-1 can monitor a first set of reference signals (for example, synchronization information or other relevant DL reference signal (RS)) for obtaining fine time and frequency information in the second cell 340. The first device 310-1 may determine the downlink timing of the second cell 340 based on the first set of reference signals. For example, the device 320-1 can transmit 4015 e.g. a synchronization signal block (SSB) or e.g. tracking reference signal (TRS) to the first device 310-1 in the second cell 340. The first device 310-1 can obtain the downlink timing based on the DL RS, e.g. the SSB. The device 320 may transmit 4020 a PDCCH order for the UE to initiate a RA procedure. It should be noted that device 320 can transmit any proper number of SSBs in the second cell 340.

The device 320-2 can transmit a second set of reference signal to the first device 310-1. For example, in some embodiments, the device 320-2 can transmit 4025 an CSI reference signal in the second cell 340 to the first device 310-1. For example, the CSI reference signal can be pre-configured CSI reference signals. In some embodiments, the first device 310-1 can measure the CSI reference signal and determine the CSI based on a measurement of the CSI reference signal.

The first device 310-1 transmits 4030 a preamble to the device 320-2 in the second cell 340 for initiating a random access procedure. For example, the preamble may comprise cyclic prefix and a sequence. In some embodiments, the device 320-2 may determine a physical random access channel (PRACH) configuration index and transmit the PRACH configuration index in some RRC message e.g. system information blocks or dedicated signaling before the SCell activation. The first device 310-1 can determine the preamble based on the PRACH configuration index. In some embodiments, the random access procedure can be contention-free. Alternatively, the random access procedure can be contention-based. In some embodiments, once the DL timing of the second cell 340 has been acquired, the first device 310-1 can start the random access procedure.

In other embodiments, the second set of reference signal may comprise signals different from the first set of reference signals (for example, the CSI-RS). The first device 310 may start monitor or measure the second set of reference signal after receiving the activation command, or acquiring the downlink timing of the second cell 340, or the transmission of the preamble. The device 320-2 may transmit 4035 a set of reference signals for CSI measurement in the second cell 340 to the first device 310-1. For example, the device 320-2 may transmit one reference signal to the first device 310-1. Alternatively, the device 320-2 may transmit a plurality of reference signals. It should be noted that the set of reference signals can be any suitable number of reference signals. In some embodiments, if the activation command is sent or the acknowledgement in response to the activation indication is received, the device 320-2 can transmit the set of reference signals. In other words, the transmission of the set of reference signals can be triggered by the reception of the acknowledgment or by the transmission of activation command. Alternatively, if the preamble for the random access procedure is received, the device 320-2 can transmit the set of reference signals. In this situation, the transmission of the set of reference signals can be triggered by the reception of the preamble. In some embodiments, the device 320-2 can transmit additional reference signals to the first device 310-1 in the second cell 340. For example, additional reference signals can be triggered by the activation indication or can be triggered by the reception of the preamble.

In some embodiments, the device 320-2 can transmit reference signals in a time interval specific to the second cell 340. For example, the time interval can be smaller or equal to a given configured time interval. The CSI-RS can be transmitted for the given configured time interval. The device 320-2 can transmit more reference signals. In this way, the latency can be further reduced.

In some embodiments, the reference signals to be measured for CSI can be transmitted by the device 320-2 specifically being triggered for this purpose. In other embodiments, such transmission of reference signals can be sent by the device 320-2 once the device 320-2 receives the preamble. In a further embodiment, the transmission of reference signals can be sent by the device 320-2 starting from receiving the HARQ ACK in response to the activation command—and for a given period of time (e.g. until the first device 310-1 has sent valid CSI report).

The first device 310-1 measures the second set of reference signals while performing activation of the second cell and the random access procedure. In some embodiments, the first device 310-1 can measure reference signal received power (RSRP) on the set of reference signals. In other embodiments, the first device 310-1 can measure reference signal received quality (RSRQ) on the set of reference signals. Alternatively or in addition, the first device 310-1 can obtain received signal strength indicator (RSSI) of the set of reference signals. Based on these measurements and alternatively other measurements, the UE may obtain the information needed for the CSI report. In this way, the measurement of the set of reference signals can be performed while activating the second cell and the random access procedure, thereby reducing delay for activating the second cell 340.

In some embodiments, the device 320-2 can transmit configuration information which may indicate a measurement configuration. For example, the measurement configuration can comprise one or more of: a reference signal type, a measurement periodicity, a measurement RS transmission period specific to the second cell 340. For example, the device 320-2 can configure a shorter measurement RS and/or period or periodicity. In this way, the delay of activation of the SCell can be reduced. The measurement configuration can also indicate where to measure the second set of reference signals in time domain. Alternatively or in addition, the measurement configuration can also indicate where to measure the second set of reference signals in frequency domain.

The first device 310-1 can generate a CSI report based on measurements of the set of reference signals. In wireless communications, the term “channel state information (CSI)” refers to known channel properties of a communication link. This information describes how a signal propagates from the transmitter to the receiver and represents the combined effect of, for example, scattering, fading, and power decay with distance.

The device 320-2 can transmit 4040 a response to the first device 310-1. For example, after the preamble is detected, the device 320-2 can assign uplink resources for the second cell 340 and transmit the response. In some embodiments, the response can comprise timing alignment information. Alternatively or in addition, the response can comprise an initial UL grant. In other embodiments, the response can comprise an assignment of a temporary cell radio network temporary identifier (C-RNTI). Optionally, the device 320-2 can transmit 4045 a request for the channel state information to the first device 310-1.

The first device 310-1 transmits 4050 a CSI report to the device 320-2. In some embodiments, the device 320 can transmit resource information which indicates additional resources for the uplink channel. In this situation, the channel state information can be transmitted on the additional resources. In this way, the delay of activation of the SCell can be reduced.

In some embodiments, if the first device 310-1 receives the request for the channel state information, the first device 310-1 may transmit the channel state information. Alternatively, the channel state information can be transmitted immediately after the random access procedure is completed.

According to embodiments of the present disclosure, it proposes an enhancement to the UE PUCCH SCell activation delay requirement which is to define the requirements based on the fact that UE can measure the reference signals for CSI while (i.e., in parallel) performing cell activation and the random access procedure.

With this UE behavior the time for the UE to be able to transmit valid CSI report in UL can be greatly reduced and thereby reduce the overall PUCCH SCell activation delay. The requirements will be defined such that UE need to perform CSI-RS measurement for CSI reporting simultaneously while performing cell activation and random access procedure. The delay requirement of the activation of the second cell may be determined based on: a timing between a downlink data transmission and acknowledgement, a time duration for the activation of the second cell, and a time duration for the random access procedure. Alternatively, the delay requirement of the activation of the second cell may be determined not considering additional time period for CSI measurements and reporting. In one solution this would be defined as: upon receiving SCell activation command in slot n, the UE shall be capable to transmit valid CSI report and apply actions related to the activation command for the SCell being activated no later than in slot

$$n + \frac{{T}_{H A R Q} + {T}_{activation\_time}}{NR slot length} + {T}_{R A C H} ,$$

where T_{HARQ} represents the timing between DL data transmission and acknowledgement; T_{activation_time} represents the SCell activation delay in millisecond; T_{RACH} represents a duration for the random access procedure. In some embodiments, T_{RACH} can comprise: (1) T₁ which represents the delay uncertainty in acquiring the first available PRACH occasion in the PUCCH SCell and can be up to X subframes and the actual value of T₁ shall depend upon the PRACH configuration used in the PUCCH SCell, (2) T₂ which represents the delay for obtaining a valid TA command for the sTAG to which the SCell configured with PUCCH belongs (or PSCell) and can be up to Y subframes, and (3) T₃ which represents the delay for applying the received TA for uplink transmission and can be Z subframes.

According to some embodiments, the network may transmit additional CSI-RS triggered by the PUCCH SCell activation command (and potentially based on receiving the HARQ Ack from the UE). Early CSI reporting from the UE can be enabled based on scheduled, triggered, polled or bundled CSI report. Moreover, the network may configure shorter activation specific CSI-RS periodicity and/or more PUCCH resources for CSI reporting.

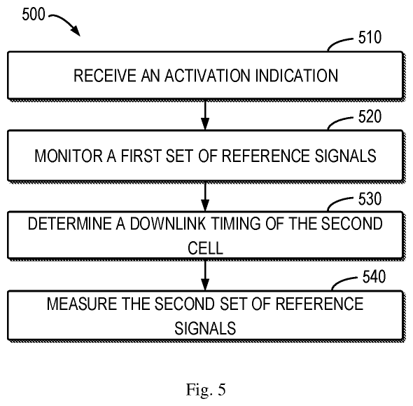

FIG. 5 shows a flowchart of an example method 500 in accordance with some example embodiments of the present disclosure. For the purpose of discussion, the method 500 will be described from the perspective of the first device 310.

At block 510, the first device 310-1 receives an activation indication in first cell 330 from the device 320 (for example, the device 320-1) to activate the second cell 340. The first device 310-1 is expected to perform PUCCH transmission on the second cell 340. For example, the activation indication can comprise an identity of the second cell 340. In some embodiments, the first device 310-1 can be configured with more than one SCells. The device 320 may configure a SCell in a deactivated state. Alternatively, the device 320 may configure a SCell in an activated state. The first device 310-1 can be configured with the information that the second cell 340 can be regarded as the SCell with PUCCH. The activation indication can be transmitted in any proper signaling.

In some embodiments, the first device 310-1 can transmit an acknowledgement in response to the activation indication to the device 320 in the first cell 330. For example, the HARQ acknowledgement can be transmitted.

After the first device 310-1 sends the acknowledgment, the first device 310-1 may obtain DL timing of the SCell. At block 520, the first device 310-1 monitors a first set of reference signals in the second cell 340. The first device 310-1 determines, at block 530, a downlink timing of the second cell 340 based on the first set of reference signals. For example, the device 320 can transmit a synchronization signal block (SSB) or TRS (i.e., the first set of reference signals) to the first device 310-1 in the second cell 340. Additionally, the first device 310-1 receives the second set of reference signals in a time interval specific to the secondary cell. The first device 310-1 can obtain the downlink timing based on the SSB and/or TRS. The device 320 may transmit a PDCCH order for initiating a RA procedure. It should be noted that device 320 can transmit any proper number of SSBs or TRSs in the second cell 340.

In some embodiments, the first device 310-1 transmits a preamble to the device 320 in the second cell 340 for a random access procedure. For example, the preamble may comprise cyclic prefix and a sequence. In some embodiments, the device 320 may determine a physical random access channel (PRACH) configuration index and transmit the PRACH configuration index in system information blocks. The first device 310-1 can determine the preamble based on the PRACH configuration index. In some embodiments, the random access procedure can be contention-free. Alternatively, the random access procedure can be contention-based. In some embodiments, once the DL timing of the second cell 340 has been acquired, the first device 310-1 can start the random access procedure.

The first device 310-1 receives a second set of reference signals in the second cell 340 from the device 320. For example, the device 320 may transmit one reference signal to the first device 310-1. Alternatively, the device 320 may transmit a plurality of reference signals. It should be noted that the set of reference signals can be any suitable number of reference signals. In some embodiments, if the acknowledgement to the activation indication is received, the device 320 can transmit the set of reference signals. In other words, the transmission of the set of reference signals may be triggered by the reception of the acknowledgement. Alternatively, if the preamble for the random access procedure is received, the device 320 may transmit the set of reference signals. In this situation, the transmission of the set of reference signals can be triggered by the reception of the preamble. In some embodiments, the device 320 can transmit additional reference signals to the first device 310-1 in the second cell 340. For example, additional reference signals can be triggered by the activation indication.

In some embodiments, the first device 310-1 can receive the second set of reference signals in a time interval specific to the secondary cell. The first device 310-1 can receive more reference signals. In this way, the latency can be further reduced.

In some embodiments, the reference signals to be measured for CSI can be transmitted by the device 320 specifically triggered for this purpose. In other embodiments, such transmission of reference signals can be sent by the device 320 once the device 320 receives the preamble. In a further embodiment, the transmission of reference signals can be sent by the device 320 starting from receiving the HARQ ACK in response to the activation command and for a given period of time (e.g. until the first device 310-1 has sent valid CSI report).

At block 540, the first device 310-1 measures the second set of reference signals while activation and during the random access procedure. In some embodiments, the first device 310-1 can measure reference signal received power (RSRP) on the set of reference signals. In other embodiments, the first device 310-1 can measure reference signal received quality (RSRQ) on the set of reference signals. Alternatively or in addition, the first device 310-1 can obtain received signal strength indicator (RSSI) of the set of reference signals. In other embodiments, the first device 310-1 can measure reference signals and evaluate the CSI. In this way, the measurement of the set of reference signals can be performed while activating the second cell and the random access procedure, thereby reducing delay for activating the SCell.

In some embodiments, the device 320 can transmit configuration information which may indicate e.g. configured measured RS, a measurement period specific to the second cell 340. For example, the device 320 can configure a DL RS with a shorter measurement periodicity. In this way, the delay of activation of the SCell can be reduced. The measurement configuration can also indicate where to measure the second set of reference signals in time domain. Alternatively or in addition, the measurement configuration can also indicate where to measure the second set of reference signals in frequency domain.

In some embodiments, the first device 310-1 can generate a CSI report based on measurements of the set of reference signals. In wireless communications, the term “channel state information (CSI)” refers to known channel properties of a communication link. This information describes how a signal propagates from the transmitter to the receiver and represents the combined effect of, for example, scattering, fading, and power decay with distance.

The first device 310-1 can receive a response from the device 320. For example, after the preamble is detected, the device 320 can assign uplink resources for the second cell 340 and transmit the response using PDSCH. In some embodiments, the response can comprise timing alignment information. Alternatively or in addition, the response can comprise an initial UL grant. In other embodiments, the response can comprise an assignment of a temporary cell radio network temporary identifier (C-RNTI). The device 320 can transmit a request for the channel state information to the first device 310-1.

The first device 310-1 can transmit a CSI report to the device 320. In some embodiments, the device 320 can transmit resource information which indicates additional resources for the uplink channel. In this situation, the channel state information can be transmitted on the additional resources. In this way, the delay of activation of the SCell can be reduced.

In some embodiments, if the first device 310-1 receives the request for the channel state information, the first device 310-1 may transmit the channel state information. Alternatively, the channel state information can be transmitted after the random access procedure is completed.

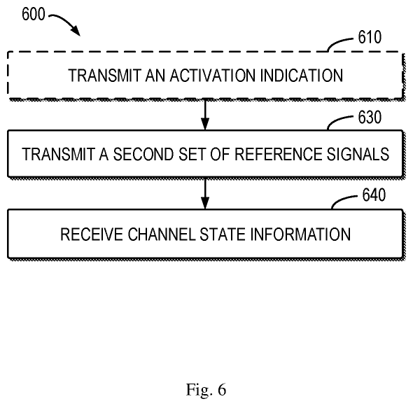

FIG. 6 shows a flowchart of an example method 600 in accordance with some example embodiments of the present disclosure. For the purpose of discussion, the method 600 will be described from the perspective of the device 320.

In some embodiments, at block 610, the device 320 transmits an activation indication in first cell 330 to the first device 310-1 to activate the second cell 340. The first device 310-1 can perform PUCCH transmission on the second cell 340. For example, the activation indication can comprise an identity or identifier of the second cell 340. In some embodiments, the first device 310-1 can be configured with more than one SCells. The device 320 may configure a SCell in a deactivated state. Alternatively, the device 320 may configure a SCell in an activated state. The first device 310-1 can be configured with the information that the second cell 340 can be regarded as the SCell with PUCCH. The activation indication can be transmitted in any proper signaling.

In some embodiments, the device 320 can receive an acknowledgement to the activation indication from the first device 310-1 in the first cell 330. For example, the HARQ acknowledgement can be transmitted.

In some embodiments, the device 320 can transmit a first set of reference signals (for example, a synchronization signal block (SSB) or TRS) to the first device 310-1 in the second cell 340. The first device 310-1 can obtain the downlink timing based on the SSB. The device 320 may transmit a PDCCH order for initiating a RA procedure. It should be noted that the device 320 can transmit any proper number of SSBs in the second cell 340.

In some embodiments, the device 320 can transmit CSI-RS e.g. an activation CSI reference signal in the second cell 340 to the first device 310-1. For example, the activation CSI reference signal can be pre-configured CSI reference signals.

In some embodiments, the device 320 can receive a preamble from the first device 310-1 in the second cell 340 for a random access procedure. For example, the preamble may comprise cyclic prefix and a sequence. In some embodiments, the device 320 may determine a physical random access channel (PRACH) configuration index and transmit the PRACH configuration index in system information blocks. The first device 310-1 can determine the preamble based on the PRACH configuration index. In some embodiments, the random access procedure can be contention-free. Alternatively, the random access procedure can be contention-based. In some embodiments, once the DL timing of the second cell 340 has been acquired, the first device 310-1 can start the random access procedure.

At block 630, the device 320 transmits a second set of reference signals in the second cell 340 to the first device 310-1. For example, the device 320 may transmit one reference signal to the first device 310-1. Alternatively, the device 320 may transmit a plurality of reference signals. It should be noted that the set of reference signals can be any suitable number of reference signals. In some embodiments, if the acknowledgement to the activation indication is received, the device 320 can transmit the set of reference signals. In other words, the transmission of the set of reference signals can be triggered by the reception of the acknowledgment. Alternatively, if the preamble for the random access procedure is received, the device 320 can transmit the set of reference signals. In this situation, the transmission of the set of reference signals can be triggered by the reception of the preamble. In some embodiments, the device 320 can transmit additional reference signals to the first device 310-1 in the second cell 340. For example, additional reference signals can be triggered by the activation indication.

In some embodiments, the device 320 can transmit reference signals in a time interval specific to the secondary cell. The device 320 can transmit more reference signals. In this way, the latency can be further reduced.

In some embodiments, the reference signals to be measured for CSI can be transmitted by the device 320 specifically triggered for this purpose. In other embodiments, such transmission of reference signals can be sent by the device 320 once the device 320 receives the preamble. In a further embodiment, the transmission of reference signals may be sent by the device 320 starting from receiving the HARQ ACK in response to the activation command and for a given period of time (e.g. until the first device 310-1 has sent valid CSI report).

In some embodiments, the device 320 can transmit a measurement configuration which indicates e.g. a measurement period specific to the second cell 340. For example, the device 320 can configure a shorter measurement period. In this way, the delay of activation of the SCell can be reduced. The measurement configuration can also indicate where to measure the second set of reference signals in time domain. Alternatively or in addition, the measurement configuration can also indicate where to measure the second set of reference signals in frequency domain.

The device 320 can transmit a response to the first device 310-1. For example, after the preamble is detected, the device 320 can assign uplink resources for the second cell 340 and transmit the response. In some embodiments, the response can comprise timing alignment information. Alternatively or in addition, the response can comprise an initial UL grant. In other embodiments, the response can comprise an assignment of a temporary cell radio network temporary identifier (C-RNTI). The device 320 can transmit a request for the channel state information to the first device 310-1.

In some embodiments, at block 640, the device 320 receives a CSI report from the first device 310-1. In some embodiments, the device 320 can transmit resource information which indicates additional resources for the uplink channel. In this situation, the channel state information can be transmitted on the additional resources. In this way, the delay of activation of the SCell can be reduced.

In some embodiments, if the first device 310-1 receives the request for the channel state information, the first device 310-1 may transmit the channel state information. Alternatively, the channel state information can be transmitted after the random access procedure is completed.

In some example embodiments, a first apparatus capable of performing any of the method 500 (for example, the first device 310) may comprise means for performing the respective operations of the method 500. The means may be implemented in any suitable form. For example, the means may be implemented in a circuitry or software module. The first apparatus may be implemented as or included in the first device 310. In some example embodiments, the means may comprise at least one processor and at least one memory including computer program code. The at least one memory and computer program code are configured to, with the at least one processor, cause performance of the apparatus.

In some embodiments, the apparatus comprises means for receiving, at a first device and via a first cell of a second device, an activation indication to activate a second cell of a third device; means for monitoring a first set of reference signals from the second cell; means for determining, based on the first set of reference signal a downlink timing in the second cell; and means for measuring a second set of reference signals from the second cell of the third device while performing activation of the second cell and a random access procedure to the second cell.

In some embodiments, the second cell is a secondary cell configured with physical uplink control channel (PUCCH), or a primary secondary cell (PSCell).

In some embodiments, a delay requirement of the activation of the second cell is determined based on: a slot in which the activation indication is received, a timing between a downlink data transmission and acknowledgement, a time duration for the activation of the second cell, and a time duration for the random access procedure.

In some embodiments, the apparatus comprises means for receiving, from the second device, first information indicating a measurement configuration to be applied for activation of the second cell; the means for measuring the set of reference singles comprises: means for measuring the second set of reference signals based on the measurement configuration.

In some embodiments, the measurement configuration comprises at least one of: a reference signal type, where to measure the second set of reference signals in time domain, where to measure the second set of reference signals in frequency domain, or a periodicity for measuring the second set of reference signals.

In some embodiments, the apparatus comprises means for measuring, from the second device, signals in the second set of reference signals in a time interval specific to the secondary cell.

In some embodiments, the apparatus comprises means for transmitting, via the second cell to the third device, channel state information determined based on the measurement of the second set of reference signals.

In some embodiments, the apparatus comprises means receiving, from the second device, resource information indicating additional resources for an uplink physical channel; and means for transmitting channel state information determined based on the measurement of the second set of reference signals on the additional resources.

In some embodiments, the apparatus comprises means receiving, from the second device, a request for channel state information determined based on the measurement of the second set of reference signals; and means for in accordance with a determination that a request for channel state information is received from the third device, transmitting, via the second cell to the third device, the channel state information.

In some example embodiments, a second apparatus capable of performing any of the method 600 (for example, the device 320) may comprise means for performing the respective operations of the method 600. The means may be implemented in any suitable form. For example, the means may be implemented in a circuitry or software module. The first apparatus may be implemented as or included in the second device 320. In some example embodiments, the means may comprise at least one processor and at least one memory including computer program code. The at least one memory and computer program code are configured to, with the at least one processor, cause performance of the apparatus.

In some embodiments, the apparatus comprises means for transmitting, to a first device, a first set of reference signals in a second cell; and means for transmitting, to the first device, a second set of reference signals while performing a random access procedure with the first device.

In some embodiments, the second cell is a secondary cell configured with physical uplink control channel (PUCCH), or a primary secondary cell (PSCell).

In some embodiments, the apparatus further comprises means for transmitting, at a second device and to a first device, first information indicating a measurement configuration to be applied for activation of the second cell.

In some embodiments, the measurement configuration comprises at least one of: a reference signal type, where to measure the second set of reference signals in time domain, where to measure the second set of reference signals in frequency domain, or a periodicity for measuring the second set of reference signals.

In some embodiments, the means for transmitting the set of reference signals comprises: means for transmitting, to the first device, signals in the second set of reference signals in a time interval specific to the secondary cell.

In some embodiments, the means for transmitting the set of reference signals comprises: means for in accordance with a determination that an acknowledgment to the activation indication is received, transmitting the second set of reference signals.

In some embodiments, the means for transmitting the second set of reference signals comprises: means for in accordance with a determination that a preamble for the random access procedure is received, transmitting the second set of reference signals.

In some embodiments, the apparatus comprises means for transmitting, to the first device, resource information indicating additional resources for an uplink physical channel; and means for receiving, from the first device, channel state information determined based on a measurement of the second set of reference signals on the additional resources.

In some embodiments, the apparatus comprises means for transmitting, to the first device, a request for channel state information determined based on a measurement of the second set of reference signals.

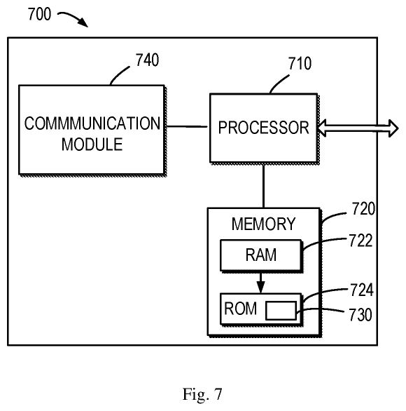

FIG. 7 is a simplified block diagram of a device 700 that is suitable for implementing example embodiments of the present disclosure. The device 700 may be provided to implement a communication device, for example, the first device 110 or the second device 120 as shown in FIG. 1. As shown, the device 700 includes one or more processors 710, one or more memories 720 coupled to the processor 710, and one or more communication modules 740 coupled to the processor 710.

The communication module 740 is for bidirectional communications. The communication module 740 has one or more communication interfaces to facilitate communication with one or more other modules or devices. The communication interfaces may represent any interface that is necessary for communication with other network elements. In some example embodiments, the communication module 740 may include at least one antenna.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The program 730 may be stored in the memory, e.g., ROM 724. The processor 710 may perform any suitable actions and processing by loading the program 730 into the RAM 722.

Example embodiments of the present disclosure may be implemented by means of the program 730 so that the device 700 may perform any process of the disclosure as discussed with reference to FIGS. 2 to 6. The example embodiments of the present disclosure may also be implemented by hardware or by a combination of software and hardware.

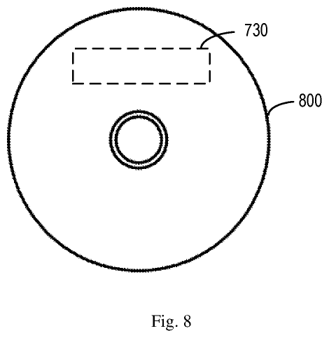

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. The computer readable medium may include any types of tangible non-volatile storage, such as ROM, EPROM, a flash memory, a hard disk, CD, DVD, and other magnetic storage and/or optical storage. FIG. 8 shows an example of the computer readable medium 800 in form of an optical storage disk. The computer readable medium has the program 730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target physical or virtual processor, to carry out any of the methods as described above with reference to FIGS. 3 to 8. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first device, comprising:
at least one processor; and
at least one memory including computer program code;
wherein the at least one memory and the computer program code are configured to, with the at least one processor, cause the first device to:
receive, at a first device and via a first cell of a second device, an activation indication to activate a second cell of a third device;
monitor a first set of reference signals from the second cell;
determine, based on the first set of reference signal a downlink timing in the second cell; and
measure a second set of reference signals from the second cell of the third device while performing activation of the second cell and a random access procedure to the second cell.

2. The first device of claim 1, wherein the second cell is a secondary cell configured with physical uplink control channel (PUCCH), or a primary secondary cell (PSCell).

3. The first device of claim 1, wherein a delay requirement of the activation of the second cell is determined based on: a slot in which the activation indication is received, a timing between a downlink data transmission and acknowledgement, a time duration for the activation of the second cell, and a time duration for the random access procedure.

4. The first device of claim 1, wherein the at least one memory and the computer program code are configured to, with the at least one processor, further cause the first device to:
receive, from the second device, first information indicating a measurement configuration to be applied for activation of the second cell;
wherein the at least one memory and the computer program code are configured to, with the at least one processor, cause the first device to measure the second set of reference signals by:
measuring the second set of reference signals based on the measurement configuration.

5. The first device of claim 4, wherein the measurement configuration comprises at least one of:
a reference signal type,
where to measure the second set of reference signals in time domain,
where to measure the second set of reference signals in frequency domain, or
a periodicity for measuring the second set of reference signals.

6. The first device of claim 1, wherein the at least one memory and the computer program code are configured to, with the at least one processor, further cause the first device to:
measure, from the second device, signals in the set of reference signals in a time interval specific to the secondary cell.

7. The first device of claim 1, wherein the at least one memory and the computer program code are configured to, with the at least one processor, further cause the first device to:
transmit, via the second cell and to the third device, channel state information determined based on the measurement of the second set of reference signals.

8.-21. (canceled)

22. A method, comprising:
receiving, at a first device and via a first cell of a second device, an activation indication to activate a second cell of a third device;
monitoring a first set of reference signals from the second cell;
determining, based on the first set of reference signal a downlink timing in the second cell; and
measuring a second set of reference signals from the second cell of the third device while performing activation of the second cell and a random access procedure to the second cell.

23. The method of claim 22, wherein the second cell is a secondary cell configured with physical uplink control channel (PUCCH), or a primary secondary cell (PSCell).

24. The method of claim 22, wherein a delay requirement of the activation of the second cell is determined based on: a slot in which the activation indication is received, a timing between a downlink data transmission and acknowledgement, a time duration for the activation of the second cell, and a time duration for the random access procedure.

25. The method of claim 22, further comprising:
receiving, from the second device, first information indicating a measurement configuration to be applied for activation of the second cell; and
wherein measuring the second set of reference signals comprises:
measuring the second set of reference signals based on the measurement configuration.

26. The method of claim 25, wherein the measurement configuration comprises at least one of:
a reference signal type,
where to measure the second set of reference signals in time domain,
where to measure the second set of reference signals in frequency domain, or
a periodicity for measuring the second set of reference signals.

27. The method of claim 22, further comprising:
measuring, from the second device, signals in the second set of reference signals in a time interval specific to the secondary cell.

28. The method of claim 22, further comprising:
transmitting, via the second cell to the third device, channel state information determined based on the measurement of the second set of reference signals.

29.-43. (canceled)

44. A non-transitory computer readable storage medium comprising program instructions for causing a first device to perform:
receiving, at the first device and via a first cell of a second device, an activation indication to activate a second cell of a third device;
monitoring a first set of reference signals from the second cell;
determining, based on the first set of reference signal a downlink timing in the second cell; and
measuring a second set of reference signals from the second cell of the third device while performing activation of the second cell and a random access procedure to the second cell.

45. The non-transitory computer readable storage medium of claim 44, wherein the second cell is a secondary cell configured with physical uplink control channel (PUCCH), or a primary secondary cell (PSCell).

46. The non-transitory computer readable storage medium of claim 44, wherein a delay requirement of the activation of the second cell is determined based on: a slot in which the activation indication is received, a timing between a downlink data transmission and acknowledgement, a time duration for the activation of the second cell, and a time duration for the random access procedure.

47. The non-transitory computer readable storage medium of claim 44, further comprising program instructions for causing the first device to perform:
receiving, from the second device, first information indicating a measurement configuration to be applied for activation of the second cell; and
wherein measuring the second set of reference signals comprises:
measuring the second set of reference signals based on the measurement configuration.

48. The non-transitory computer readable storage medium of claim 47, wherein the measurement configuration comprises at least one of:
a reference signal type,
where to measure the second set of reference signals in time domain,
where to measure the second set of reference signals in frequency domain, or
a periodicity for measuring the second set of reference signals.

49. The non-transitory computer readable storage medium of claim 44, further comprising program instructions for causing the first device to perform:
measuring, from the second device, signals in the second set of reference signals in a time interval specific to the secondary cell.
